(19) United States
(12) Patent Application Publication
(10) Pub. No.: US 2024/0051381 A1
(43) Pub. Date: Feb. 15, 2024

(54) SELF POWERING SHAFT

(71) Applicant: ANGELO VINCENT QUAGLINO, III, CHALMETTE, LA (US)

(72) Inventor: ANGELO VINCENT QUAGLINO, III, CHALMETTE, LA (US)

(21) Appl. No.: 18/447,521

(22) Filed: Aug. 10, 2023

Related U.S. Application Data
(60) Provisional application No. 63/396,850, filed on Aug. 10, 2022.

(51) Int. Cl. B60K 6/26; B60K 6/485

(52) U.S. Cl. CPC B60K 6/26; B60K 6/485; B60K 2006/4808

(57) ABSTRACT

A system and method for improving the efficiency of internal combustion engine driven vehicles using a supplemental electric drive power source on a drive shaft with an electric motor and generator placed in series. As speed of the vehicle increases, the speed of the driveshaft will increase, therein producing more power at the driveshaft via the electric motor and generator assembly. As the generator produces more power, the electric motor will have more power going to it until a desired speed is achieved. The desired speed will be maintained by the wheels turning the rear axle therein turning the generator and the electric motor. This will allow the internal combustion motor to maintain the vehicle's highway speeds at the same rpm but with less load causing an exponential increase in fuel efficiency as the Self Powering Shaft shall supplement required vehicle force/power output.

This application claims priority from U.S. Provisional Application No. 63/396,850 (the '850 application) filed Aug. 10, 2022. The '850 application is incorporated by reference.

### BACKGROUND OF THE INVENTION

The invention relates to devices and methods for improving fuel efficiency in internal combustion driven motor vehicles.

The standard automobile power system generally consists of a motor powered by internal combustion, where the force of fossil fuel is compressed and ignited, by which it pushes down a piston, thus turning a crankshaft, therefore turning a flywheel. From the flywheel power is transferred to a transmission, where the gearing ratio determines the speed and force by which the power is routed out of the transmission to a drive shaft, then to the rear end gearing, turning the wheels.

In today's modern world, the search for the answer to the problems of expendable fossil fuels and uses thereof have eluded us. Our dependence on such fuels is an environmental and economic strain. The immediate resolve would be to stop using fossil fuels, unfortunately this is not a feasible option due to the lack of technology to replace fossil fuel motors and still get the desired performance. The object of the proposed invention is to improve fuel efficiency and longevity for the standard automobile.

### SUMMARY OF THE INVENTION

The object of the present invention herein shall be referred to as a Self-Powering Shaft (“SP S”) to improve fuel efficiency in most existing rear wheel and some front wheel and four-wheel drive vehicles. The inventive Self-Powering Shaft does not replace any major drive components (motor, transmission) of the standard automobile, with installation on current vehicles being relatively easy to integrate along the existing drive shaft of a rear wheel drive train assembly. The Self-Powering Shaft can also be used in many other applications. The Self-Powering Shaft modifies the drive shaft of an existing rear wheel drive train assembly by adding at least one electric generator and at least one electric motor, concentrically rotating by mechanical connections to the drive shaft both with and on the same axis of rotation as the drive shaft. The vehicle's drive shaft that runs from the rear of the transmission to the rear differential will be driven to rotate and drive the electric generator and will then be turned and driven by the electric motor. The forward momentum of the vehicle and wheels rotating with the rear axle shall keep the drive shaft spinning, therein turning the electric generator powering the electric motor. This will take a majority of the load off the motor, reducing required internal combustion motor rpm. The load of an internal combustion motor is the main culprit in fuel deficiency. For example, when driving up a steep hill, the MPG of a vehicle drops dramatically. However, when going downhill the MPG jumps exponentially.

The type of electric motor and generator is not limited to one specific type. The components of the present invention can also be placed inside of a drive axle housing. For the purposes of explanation, the example used will be the drive shaft of a rear-wheel-drive vehicle.

Each electric generator will be wired and electrically connected to power at least one electric motor affixed to the drive shaft so that when at speed, the generator shall power at least one motor to assist in rotating the drive shaft and reducing the load on the vehicle's internal combustion motor, thereby reducing the fuel consumed to produce such rotation. A voltage regulator and switch will be installed between the wiring of the generator and electric motor to adjust the motor's voltage as the vehicle slows, causing the electric motor to produce less power and to totally stop voltage when the electric motor stops. If the regulator switches polarity, the motor will reverse in the direction of the drive shaft assisting in slowing the vehicle. It is a further object of the inventive Self-Powering Shaft to interface with integral engine control modules.

Another huge advantage of the Self-Powering Shaft is its ability to be added to tractor trailers or semi-trucks to allow the trailer to pull its own weight or at a minimum assist in the forward motion of the vehicle and slowing. The Self-Powering Shaft can be added to most progressive vehicles used today inclusive of older models, marine, farm and industrial applications.

### BRIEF DESCRIPTION OF THE DRAWINGS

FIG. 1 depicts a plan view of the SPS concept affixed to the drive shaft of a vehicle's rear wheel drive train assembly, with the addition of a plurality of electric generators and electric motors concentrically mounted on the drive shaft.

FIG. 2-2 is a cross sectional view of the front electric motor concentrically mounted on the drive shaft.

FIG. 3-3 is a cross sectional view of the front electric generator concentrically mounted on the drive shaft.

### DETAILED DESCRIPTION OF THE INVENTION

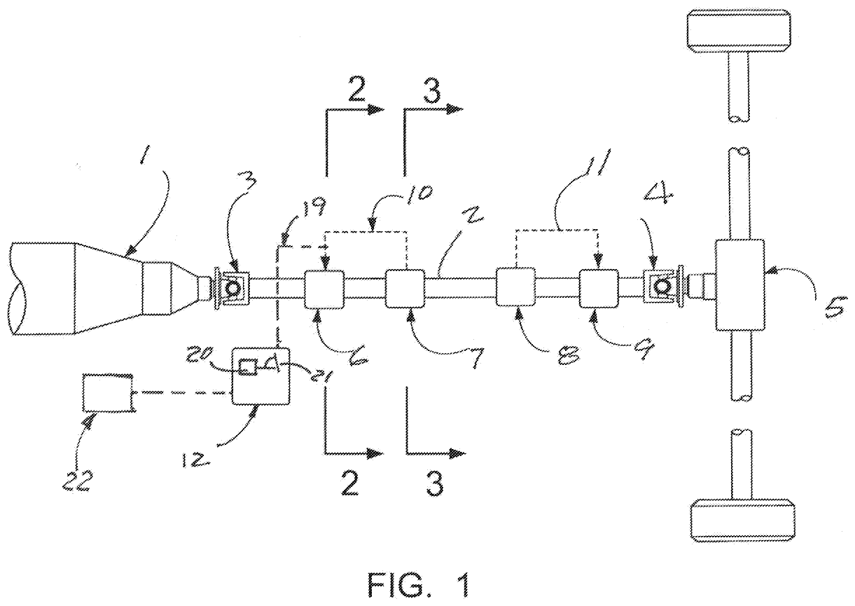

In FIG. 1 a plan view of the drive shaft 2 of an existing rear wheel drive train assembly is depicted with the addition of at least one combination of electric generators 7 and 9 and electric motors 6 and 8 concentrically mounted on the drive shaft 2 to rotate by mechanical connection to the drive shaft 2, with front U-joint 3 and rear U-joint 4, running from the transmission 1 to the rear differential 5. Also shown is an electrical connection 10 between electric generator 7 and electric motor 6, and an electrical connection 11 between electric generator 9 and electric motor 8. A control box 12 shall be electrically connected by electrical connection 19 to the generators and motors at electrical connections 10 and 11 where the control box 12 contains at least one voltage regulator 20 and switch 21 for each combination of electric generators and motors. The voltage regulator 20 will adjust the voltage as the vehicle slows causing the electric motor to produce less power, with a switch 21 to totally stop voltage to the motor when slowing the vehicle. If the regulator 20 switches polarity from the generator to the motor, it will cause the motor to try to spin in the opposite direction of the drive shaft 2 causing slowing of the vehicle by assisting in the braking of the vehicle. Also shown is an engine control module 22 interfaced with the control box 12.

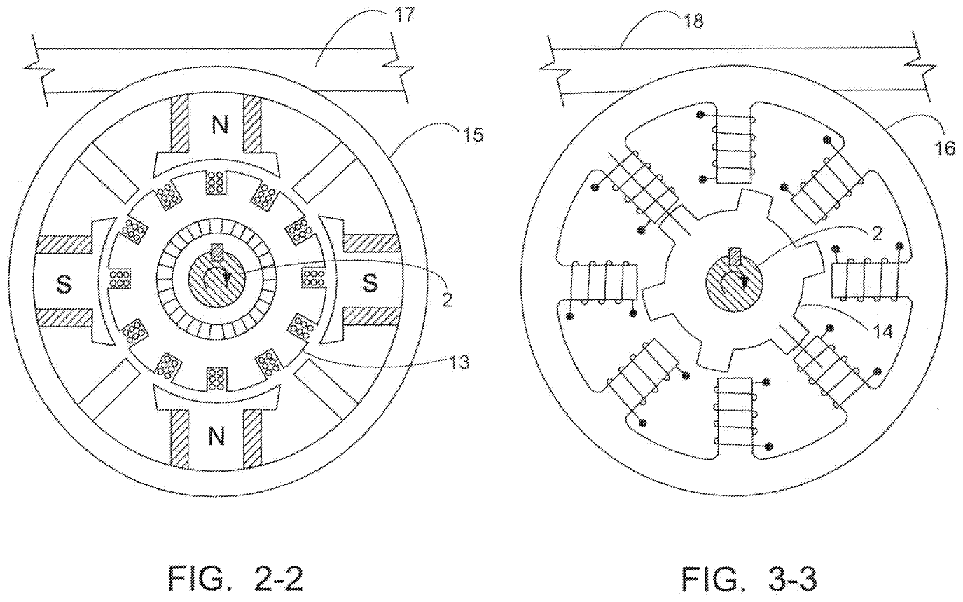

FIGS. 2-2 and FIG. 3-3 show cross sectional views of the front electric motor 6 and the front electric generator 7 respectively, with each concentrically mounted to the drive shaft 2 by mechanical connection so that the motor armature 13 and the generator armature 14 will rotate with the shaft 2. The drive shaft 2 will become the driving shaft for the front electric motor 6 and the front electric generator 7. Also shown in FIG. 2-2 is the motor armature 13, the motor outer frame 15 and a motor mount 17 for securing the electric motor 6 to a cross member of the vehicle's frame whilst permitting movement of the drive shaft 2 as it interfaces and functions with the rear differential 5 and suspension. FIG. 3-3 shows the generator armature 14, the generator outer frame 16 and a generator mount 18 for bolting the electric generator 7 to a frame cross member of the vehicle to allow movement of the drive shaft 2 as it relates to the rear differential 5 and suspension. The minimal movement of the driveshaft 2 will have a minimal effect on the components of the motor 6 and generator 7 that touch, such as brushes.

Not every application of the present invention will be installed in an identical fashion. In some cases, the existing driveshaft can be used to rotate a motor or motors and a generator or generators by concentric mounting to the driveshaft, which is to say, the axis of rotation of the driveshaft is the same for the motor or motors and a generator or generators. Alternatively, the motor or motors and a generator or generators could rotate on an axis parallel to the axis of rotation of the driveshaft with power transferred through a belt or a chain. In others, the drive shaft will need to be replaced or the present invention installed on an alternative power drive receiving power from an internal combustion driven motor. In some situations, the device will need to be installed similar to a transfer case, in others it will fasten to the vehicle's rear end or differential 5. The idea of the invention is to use an electric generator and motor in conjunction with combustion of fossil fuels to reduce the load of the internal combustion engine, thereby increasing fuel economy.

I claim:

1. A system for improving fuel efficiency of an internal combustion driven motor vehicle with a drive shaft, comprising:
at least one electric generator rotating by mechanical connection to the drive shaft;
at least one electric motor rotating by mechanical connection to the drive shaft;
an electric connection between the electric generator and the electric motor;
a control box connected electrically to the electric connection between the electric generator and the electric motor, and the control box further comprising at least one voltage regulator and switch.

2. The system of claim 1 further comprising an integral combustion motor control module to interface with the control box.

3. The system of claim 2 where the electric generator is concentrically mounted on the drive shaft to rotate by mechanical connection to the drive shaft and the electric motor is concentrically mounted on the drive shaft to rotate by mechanical connection to the drive shaft.

4. A system for improving fuel efficiency of an internal combustion driven motor vehicle with an alternative power drive receiving power from an internal combustion driven motor comprising:
at least one electric generator rotating by mechanical connection to the power drive from the internal combustion driven motor vehicle;
at least one electric motor rotating by mechanical connection to the power drive from the internal combustion driven motor vehicle;
an electric connection between the electric generator and the electric motor;
a control box connected electrically to the electric connection between the electric generator and the electric motor, and the control box further comprising at least one voltage regulator and switch.

5. The system of claim 3 further comprising an integral combustion motor control module to interface with the control box.

6. A method for improving fuel efficiency of an internal combustion motor driven vehicle with a drive shaft, comprising:
provide at least one electric generator to rotate by mechanical connection to the drive shaft;
provide at least one electric motor to rotate by mechanical connection to the drive shaft;
provide an electric connection between the electric generator and the electric motor so that the electric generator will power the electric motor to assist in rotating the drive shaft to reduce the load on the internal combustion motor;
electrically connect a control box to the electric connection between the electric generator and the electric motor, and where the control box further comprises at least one voltage regulator and switch, and;
provide an integral combustion motor control module to interface with the control box.

7. The method of claim 6 where the provided electric generator is concentrically mounted on the drive shaft to rotate by mechanical connection to the drive shaft and the provided electric motor is concentrically mounted on the drive shaft to rotate by mechanical connection to the drive shaft.

8. A method for improving fuel efficiency of an internal combustion driven motor vehicle with an alternative power drive receiving power from an internal combustion driven motor comprising:
providing at least one electric generator rotating by mechanical connection to the power drive from the internal combustion driven motor vehicle;
providing at least one electric motor rotating by mechanical connection to the power drive from the internal combustion driven motor vehicle;
providing an electric connection between the electric generator and the electric motor;
electrically connect a control box to the electric connection between the electric generator and the electric motor, and where the control box further comprises at least one voltage regulator and switch, and;
provide an integral combustion motor control module to interface with the control box.
